(19) United States
(12) Patent Application Publication
(10) Pub. No.: US 2021/0240444 A1
(43) Pub. Date: Aug. 5, 2021

(54) RANDOM NUMBER GENERATOR UTILIZING SENSOR ENTROPY

(71) Applicant: Cyber Reliant Corp., Annapolis, MD (US)

(72) Inventors: John Michael Suit, Mount Airy, MD (US); Ian Spencer Bartelt Becker, Frederick, MD (US); Katelynn Marie Linthicum, Annapolis, MD (US)

(21) Appl. No.: 17/154,859

(22) Filed: Jan. 21, 2021

Related U.S. Application Data
(60) Provisional application No. 62/970,576, filed on Feb. 5, 2020.

(51) Int. Cl. G06F 7/58

(52) U.S. Cl. CPC G06F 7/58

(57) ABSTRACT

One example method includes, receiving a plurality of disparate sensor readings from a device, determining a plurality of noise signals based on the plurality of disparate sensor readings, correlating the plurality of noise signals, generating a preliminary string of integers based on the correlated noise signals, sampling the preliminary string of integers, testing the sampled preliminary string of integers for randomness, randomizing the tested preliminary string of integers, utilizing outputs from the device, if the tested preliminary string of integers are not random and validating a string of random integers based on the tested preliminary string of integers.

### BACKGROUND

Currently, pseudo-random numbers utilized by software may be susceptible to exploitation and advanced persistent threats, thereby revealing encryption keys. Currently, true random number generation utilizes specialized hardware at a fixed location, which may be expensive to produce and/or acquire. This may leave the software development industry with little choice but to use pseudo-random number generation. Therefore, there exists a need for true random number generation for use in items such as encryption keys, encrypted content and the like.

### SUMMARY

Example embodiments of the present application provide at least a first method, comprising at least one of, receiving a plurality of disparate sensor readings from a device, determining a plurality of noise signals based on the plurality of disparate sensor readings, correlating the plurality of noise signals, generating a preliminary string of integers based on the correlated noise signals, sampling the preliminary string of integers, testing the sampled preliminary string of integers for randomness, randomizing the tested preliminary string of integers, utilizing outputs from the device, if the tested preliminary string of integers are not random and validating a string of random integers based on the tested preliminary string of integers.

A second example embodiment of the present application provides a system, comprising at least one of, a plurality of disparate sensors coupled to a device, a multi-sensor observation engine coupled to the plurality of disparate sensors that receives a plurality of disparate sensor readings from the plurality of disparate sensors, a spectrum correlation engine coupled to the multi-sensor observation engine to correlate the plurality of disparate sensor readings and output a preliminary string of integers, a randomization test engine coupled to the spectrum correlation engine to determine if the preliminary string of integers is random, at least one actuator coupled to the randomization test engine to further randomize the preliminary string of integers if the preliminary string of integers is not random and a validation engine coupled to the randomization test engine to validate the preliminary string of integers as a string of random integers.

A third example non-transitory computer readable medium comprising instructions, that when read by a processor, cause the processor to perform at least one of, receiving a plurality of disparate sensor readings from a device, determining a plurality of noise signals based on the plurality of disparate sensor readings, correlating the plurality of noise signals, generating a preliminary string of integers based on the correlated noise signals, sampling the preliminary string of integers, testing the sampled preliminary string of integers for randomness, randomizing the tested preliminary string of integers, utilizing outputs from the device, if the tested preliminary string of integers are not random and validating a string of random integers based on the tested preliminary string of integers.

### BRIEF DESCRIPTION OF THE DRAWINGS

FIG. 1 illustrates a first example system layout according to example embodiments.

FIG. 2 illustrates a second example system layout according to example embodiments.

FIG. 3 illustrates an example logic flow according to example embodiments.

FIG. 4 illustrates an example method according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

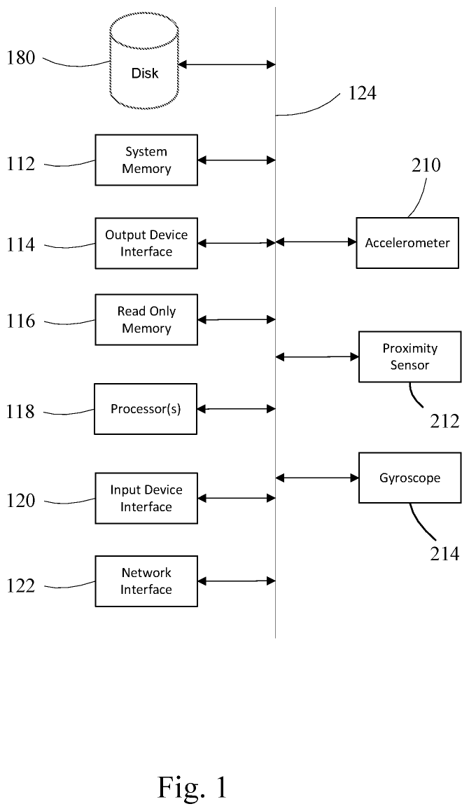

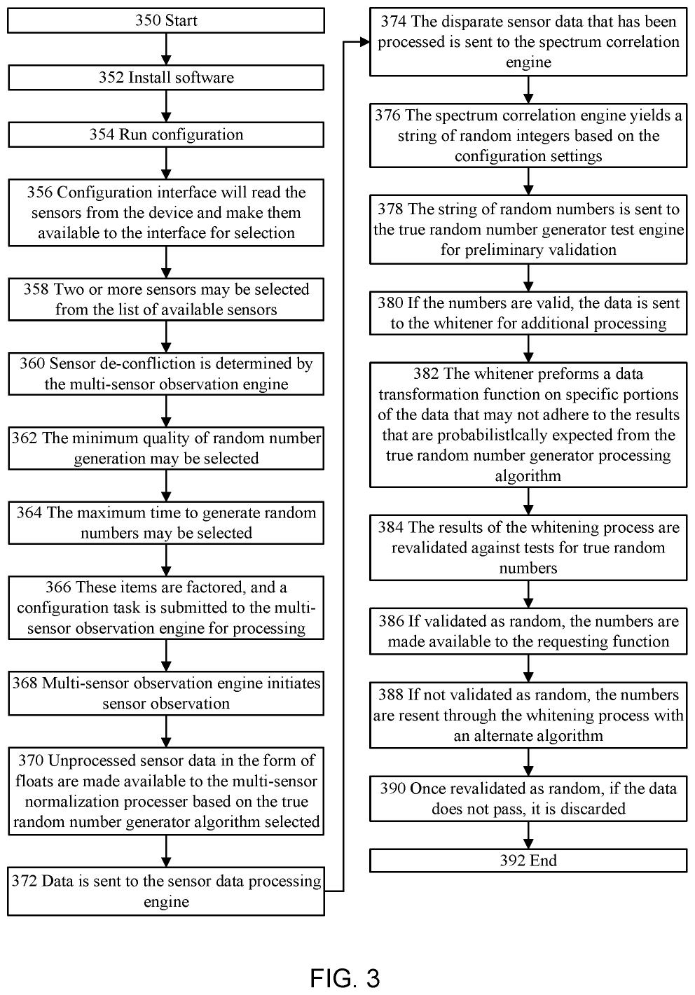

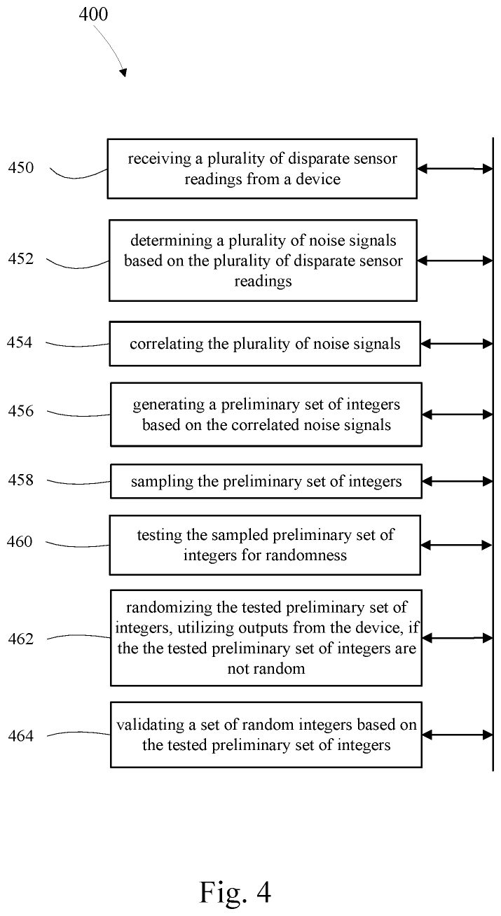

FIG. 1 depicts an electronic system which may be a computing device for execution of software associated with the operation of one or more portions or steps of processes of FIG. 3 or 4. Electronic system may be an embedded computer, personal computer or a mobile device such as a tablet computer, laptop, smart phone, software defined radio device, personal digital assistant (PDA), or other touch screen or television with one or more processors embedded therein or coupled thereto, or any other sort of computer-related electronic device having wireless connectivity and sensors.

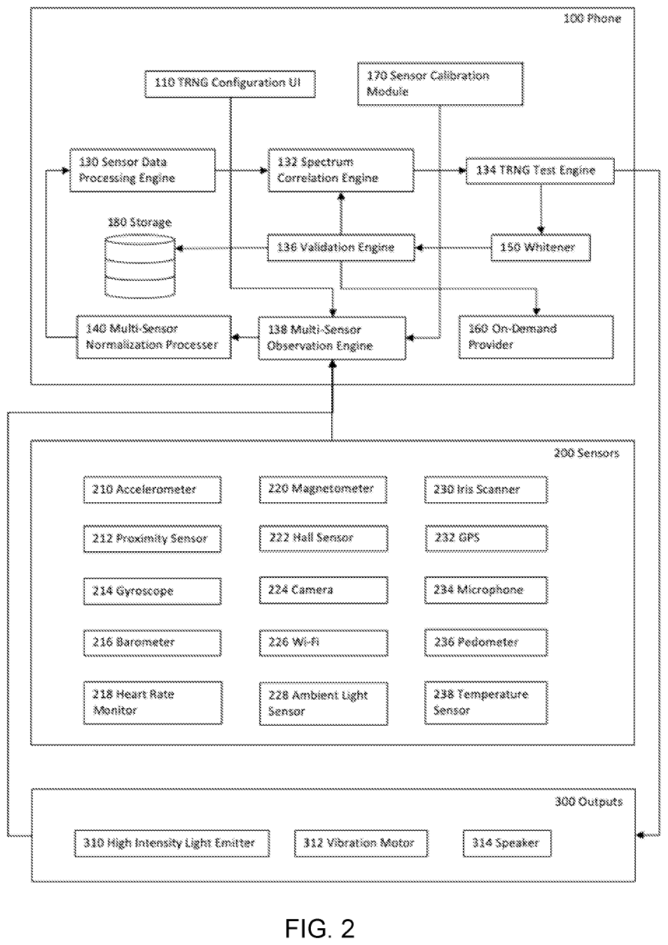

Electronic system may include various types of computer readable media and interfaces for various other types of computer readable media. In the depicted example, electronic system includes a bus 124, processor(s) 118, a system memory 112, a read-only memory (ROM) 116, a permanent storage device 180, an input device interface 120, an output device interface 114, and one or more network interfaces 122. In some implementations, the electronic system may include or be integrated with other computing devices or circuitry for operation of the various components and processes previously described. In one embodiment of the present disclosure the processor(s) 118 is coupled through the bus 124 to accelerometer 210, proximity sensor 212 and gyroscope 214. The system may contain other sensors, as is shown in FIG. 2 that may include a barometer (FIG. 2, 216), heart rate monitor (FIG. 2, 218), magnetometer (FIG. 2, 220), hall sensor (FIG. 2, 222), camera (FIG. 2, 224), Wi-Fi (FIG. 2, 226), ambient light sensor (FIG. 2, 228), iris scanner (FIG. 2, 230), GPS (FIG. 2, 232), microphone (FIG. 2, 234), pedometer (FIG. 2, 236), temperature sensor (FIG. 2, 238) and the like.

Bus 124 collectively represents all system, peripheral, and chipset buses that communicatively connect the numerous internal devices of electronic system. For instance, bus 124 communicatively connects processor(s) 118 with ROM 116, system memory 112 and permanent storage device 180.

From these various memory units, processor(s) 118 retrieves instructions to execute and data to process in order to execute the processes of the subject disclosure. The processing unit(s) can be a single processor or a multi-core processor in different implementations.

ROM 116 stores static data and instructions that are used by processor(s) 118 and other modules of the electronic system. Permanent storage device 180, on the other hand, is a read-and-write memory device. This device is a non-volatile memory unit that stores instructions and data even when the electronic system is off. Some implementations of the subject disclosure use a mass-storage device (such as a magnetic or optical disk and its corresponding disk drive) as permanent storage device 180.

Other implementations use a removable storage device (such as a floppy disk, flash drive, and its corresponding disk drive) as permanent storage device 180. Like permanent storage device 180, system memory 112 is a read-and-write memory device. However, unlike permanent storage device 180, system memory 112 is a volatile read-and-write memory, such a random access memory. System memory 112 stores some of the instructions and data that the processor needs at runtime. In some implementations, the processes of the subject disclosure are stored in system memory 112, permanent storage device 180, and/or ROM 116. From these various memory units, processor(s) 118 retrieves instructions to execute and data to process in order to execute the processes of some implementations.

Bus 124 also connects to input and output device interfaces 120 and 114, respectively. Input device interface 120 enables the user to communicate information and select commands to the electronic system. Input devices used with input device interface 120 include, for example, alphanumeric keyboards and pointing devices (also called “cursor control devices”). Output device interfaces 114 enables, for example, the display of images generated by the electronic system. Output devices used with output device interface 114 include, for example, printers and display devices, such as cathode ray tubes (CRT) or liquid crystal displays (LCD). Some implementations include devices such as a touchscreen that functions as both input and output devices.

Finally, as shown in FIG. 1, bus 124 also couples the electronic system to a network (not shown) through network interfaces 122. Network interfaces 122 may include, for example, a wireless access point (e.g., Bluetooth or Wi-Fi) or radio circuitry for connecting to a wireless access point. Network interfaces 122 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of the electronic system can be used in conjunction with the subject disclosure.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. Data generated at the client device (e.g., a result of the user interaction) can be received from the client device at the server.

The present solution describes random number generation utilizing a device having sensors. By utilizing these sensors as a source for naturally occurring entropy, true random numbers may be made available. True random number generation may be useful for industrial, consumer, entertainment, business, financial, healthcare, federal, state and local government, education, intelligence and military applications.

A configuration may be run on installed true random number generator software. The configuration interface may read the sensors from a device such as a software defined radio device or a mobile device, for example, a cellular phone and utilize available sensors. A plurality of sensors may be selected from a list of available sensors. Sensor de-confliction may be determined by the multi-sensor observation engine. Sensor de-confliction is the process of reducing the risk of data collision between the outputs of the sensors, possibly by coordinating their outputs. The minimum quality of random number generation and the maximum time to generate random numbers may be selected. A configuration task may be submitted to the multi-sensor observation engine for processing and the multi-sensor observation engine may initiate sensor observation. The unprocessed sensor data, which may be in the form of floats, may be made available to the multi-sensor normalization processer based on a true random number generator algorithm selected. The normalization processor adjusts values from the sensors having different scales and applying to the sensor data a nominally common scale. The data may be sent to the sensor data processing engine. The processed disparate sensor data may be sent to the spectrum correlation engine.

The spectrum correlation engine may yield a string of random integers based on the disparate sensor data and the configuration settings. The string of random numbers may be sent to the true random number generator test engine for preliminary validation. If the numbers are found valid, the data may be sent to the whitener for additional processing. A whitener removes underlying correlation within the data. The whitener may perform a data transformation function on specific portions of the data that may not adhere to the results that are probabilistically expected from the true random number generator processing algorithm. The results of the whitening process may be revalidated against tests for true random numbers. The algorithm may include retesting the preliminary string of integers for randomness. If truly random numbers are found, the validated numbers may be made available to the requesting function. If truly random numbers are not found the numbers may be resent through the whitening process with an alternate algorithm. Once revalidation has been performed, if the data does not pass as truly random, it may be discarded.

FIG. 2 depicts a second example system layout. The top block 100 is an example of a device such as a mobile phone having a series of processors, engines, modules and storage. Block 110 is the true random number generator (TNRG) configuration user interface (UI) which may allow the user to select specific configurations for the random number generator to follow. The TNRG configuration UI feeds into a multi-sensor observation engine 138. The multi-sensor observation engine 138 receives data from sensors 200 and having actuator outputs and feeds the observations into a multi-sensor normalization processor 140, which normalizes the observations to allows sensor to sensor leveling. The output of the multi-sensor normalization processor 140 is fed into a sensor data processing engine 130 which selects potential sensors for utilization for entropy measurement. A sensor calibration module may be coupled to the multi-sensor observation engine to calibrate the plurality of disparate sensor readings.

A spectrum correlation engine 132 receives data from the sensor data processing engine 130 correlates the disparate streams of sensor data where the data points intersect and outputs a preliminary string of integers. Spectral correlation describes correlation between frequency shifted versions of a time series. The preliminary string of integers is tested for randomness by a TRNG test engine 134 that outputs its results to a whitener 150 and the actuators in block 300 which would output data from the actuators into the multi-sensor observation engine 138. The output of the whitener 150 is fed into a validation engine 136 and refed into the spectrum correlation engine 132. If the numbers are truly random they are stored in the permanent storage device 180.

In FIG. 2 the sensors coupled to the device may be one or more of an accelerometer 210, proximity sensor 212, gyroscope 214, barometer 216, heart rate monitor 218, magnetometer 220, hall sensor 222, camera 224, Wi-Fi 226, ambient light sensor 228, iris scanner 230, GPS 232, microphone 234, pedometer 236, temperature sensor 238 and the like. The actuators coupled to the device may be one or more of a high intensity light emitter 310, vibration motor 312, speaker 314 and the like.

A configuration may be performed (FIG. 3, 354) on the installed (FIG. 3, 352) true random number generator. The configuration user interface (FIG. 2, 110) may read the sensors from a device, for example a mobile phone, and make those sensors available to the interface for selection (FIG. 3, 356). Two or more sensors may be selected from the list of available sensors (FIG. 3, 358). Sensor de-confliction may be determined by the multi-sensor observation engine (FIG. 2, 138, FIG. 3, 360). The minimum quality of random number generation (FIG. 3, 362) and the maximum time to generate random numbers may be selected (FIG. 3, 364). These items may be factored, and a configuration task may be submitted to the multi-sensor observation engine (FIG. 2, 138) for processing (FIG. 3, 366). The multi-sensor observation engine (FIG. 1, 138) may initiate sensor observation (FIG. 3, 368). Sensor observation may be accomplished by addressing the hardware interface through the software development toolkit provided for the given platform of the operating system that the device may be utilizing. The system may poll the device for available sensors. These sensors may be evaluated by the sensor data processing engine (FIG. 2, 130) in order to determine their applicability for use in random number generation given the available environmental entropy. If a subset of sensors is selected by the sensor data processing engine (FIG. 2, 130), sensor data may be evaluated by transforming the raw or unprocessed data. The unprocessed sensor data, in the form of floats, may be made available to the multi-sensor normalization processer (FIG. 2, 140) based on the true random number generator algorithm selected (FIG. 3, 370). Those algorithms that are suitable given the environmental entropy available may be selectable. Suitable algorithm filtering may be accomplished by a matrix lookup of sensor thresholds for entropy in scientific applications. The data may be sent to the sensor data processing engine (FIG. 2, 130, FIG. 3, 372). Data may be filtered based on the algorithm chosen for use by the spectrum correlation engine (FIG. 2, 132). The algorithm being utilized may compare the data provided may be based on thresholds determined by the entropy available in the environment. Streams of data may be correlated based on these results.

Disparate sensor data that has been processed may be sent to the spectrum correlation engine (FIG. 2, 132, FIG. 3, 374). The spectrum correlation engine (FIG. 2, 132) may yield a string of random integers (FIG. 3, 376). Spectrum correlation may be accomplished by the correlation of the disparate streams of sensor data where the data points intersect. A number may be generated at these intersection points based on a cyclical timer utilizing system timing. The string of random numbers may be sent to the true random number generator test engine (FIG. 2, 134) for preliminary validation (FIG. 3, 378). The test engine (FIG. 2, 134) may utilize the NIST SP 800-22 statistical test suite or the like for random and pseudorandom number testing. If the numbers are not random, device outputs (FIG. 2, 300) may be employed to induce additional environmental entropy, such as, the production of sound waves via an internal speaker or vibration motor (FIG. 2, 312). If the numbers are random, the data may be sent to the whitener (FIG. 2, 150) for additional processing (FIG. 3, 380). The whitener (FIG. 2, 150) may perform a data transformation function on specific portions of the data that may not adhere to the results that are probabilistically expected from the true random number generator processing algorithm (FIG. 3, 382). The results of the whitening process may be revalidated against tests for true random numbers (FIG. 3, 384). A Poisson distribution test may optionally be generated through the configuration settings. If the numbers are validated, they may be made available to the requesting function (FIG. 3, 386). If the numbers are not validated, they may be resent through the whitening process utilizing an alternate algorithm (FIG. 3, 388). Once revalidated, if the data does not pass the randomization test, it may be discarded (FIG. 3, 390).

The example logic flow of FIG. 3 may include at least one of the following, start 350, install software 352, run configuration 354, where the configuration interface will read 356 the sensors from a device such as a mobile phone and make them available to the interface for selection. Two or more sensors may be selected 358 from the list of available sensors, a sensor de-confliction 360 may be determined by the multi-sensor observation engine, where the minimum quality of random number generation 362 and the maximum time to generate random numbers may be selected 364. A configuration task may be submitted 366 to the multi-sensor observation engine for processing, the multi-sensor observation engine may initiate 368 a sensor observation, where unprocessed sensor data in the form of floats are made available 370 to the multi-sensor normalization processer based on the true random number generator algorithm selected. Data may be sent 372 to the sensor data processing engine and the disparate sensor data that has been processed may be sent 374 to the spectrum correlation engine. The spectrum correlation engine may yield 376 a string of random integers based on the configuration settings, the string of random numbers may be sent 378 to the true random number generator test engine for preliminary validation. If the numbers are valid, the data may be sent 380 to the whitener for additional processing, the whitener may perform a data transformation function 382 on specific portions of the data that may not adhere to the results that are probabilistically expected from the true random number generator processing algorithm. The results of the whitening process may be revalidated 384 against tests for true random numbers. If validated as random, the numbers are made available 386 to the requesting function, if not validated as random, the numbers are then resent 388 through the whitening process with the alternate algorithm, once revalidated 390, if the data does not pass it may be discarded, and the process ends 392.

FIG. 4 depicts an example method, comprising at least one of, receiving 450 a plurality of disparate sensor readings from a device, determining 452 a plurality of noise signals based on the plurality of disparate sensor readings and correlating 454 the plurality of noise signals. The method further provides generating 456 a preliminary string of integers based on the correlated noise signals, sampling 458 the preliminary string of integers, testing 460 the sampled preliminary string of integers for randomness and randomizing 462 the tested preliminary string of integers. The method also provides utilizing outputs from the device, if the tested preliminary string of integers are not random and validating 464 a string of random integers based on the tested preliminary string of integers.

An example system, includes at least one of, a plurality of disparate sensors coupled to a device, a multi-sensor observation engine coupled to the plurality of disparate sensors that receives a plurality of disparate sensor readings from the plurality of disparate sensors and a spectrum correlation engine coupled to the multi-sensor observation engine to correlate the plurality of disparate sensor readings and output a preliminary string of integers. The system further includes a randomization test engine coupled to the spectrum correlation engine to determine if the preliminary string of integers is random, at least one actuator may be coupled to the randomization test engine to further randomize the preliminary string of integers if the preliminary string of integers is not random and output to the multi-sensor observation engine and a validation engine coupled to the randomization test engine to validate the preliminary string of integers as a string of random integers.

An example non-transitory computer readable medium comprising instructions, that when read by a processor, cause the processor to perform at least one of, receiving a plurality of disparate sensor readings from a device, determining a plurality of noise signals based on the plurality of disparate sensor readings and correlating the plurality of noise signals, generating a preliminary string of integers based on the correlated noise signals. The processor also performs sampling the preliminary string of integers, testing the sampled preliminary string of integers for randomness, randomizing the tested preliminary string of integers, utilizing outputs from the device, if the tested preliminary string of integers are not random and validating a string of random integers based on the tested preliminary string of integers.

The present solution may be suitable for software environments where random numbers are sought in devices utilizing sensors. This may include software development for use in industrial, consumer, entertainment, business, financial, healthcare, federal, state and local government, education, intelligence and military applications. The present solution describes a system and method to achieve true random number generation with a device having sensors. By utilizing sensors as a source for naturally occurring entropy and whitening, true random numbers may be made available by the system to a requesting function application, individual user, or may be made available for other random number applications.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving a plurality of disparate sensor readings from a device;
determining a plurality of noise signals based on the plurality of disparate sensor readings;
correlating the plurality of noise signals;
generating a preliminary string of integers based on the correlated noise signals;
sampling the preliminary string of integers;
testing the sampled preliminary string of integers for randomness;
randomizing the tested preliminary string of integers, utilizing outputs from the device, if the tested preliminary string of integers are not random; and
validating a string of random integers based on the tested preliminary string of integers.

2. The method of claim 1, further comprising determining a plurality of disparate sensors of the device.

3. The method of claim 1, further comprising de-conflicting the plurality of disparate sensor readings.

4. The method of claim 1, further comprising whitening the preliminary string of integers.

5. The method of claim 4, further comprising retesting the preliminary string of integers for randomness.

6. The method of claim 5, further comprising whitening a portion of the tested preliminary string of integers that was found not random.

7. The method of claim 1, wherein the plurality of noise signals are float values.

8. A system, comprising:
a plurality of disparate sensors coupled to a device;
a multi-sensor observation engine coupled to the plurality of disparate sensors that receives a plurality of disparate sensor readings from the plurality of disparate sensors;
a spectrum correlation engine coupled to the multi-sensor observation engine to correlate the plurality of disparate sensor readings and output a preliminary string of integers;
a randomization test engine coupled to the spectrum correlation engine to determine if the preliminary string of integers is random;
at least one actuator coupled to the randomization test engine to further randomize the preliminary string of integers if the preliminary string of integers is not random and output to the multi-sensor observation engine; and
a validation engine coupled to the randomization test engine to validate the preliminary string of integers as a string of random integers.

9. The system of claim 8, further comprising a whitener coupled to the randomization test engine to further randomize the preliminary string of integers.

10. The system of claim 8, further comprising a multi-sensor normalization processor coupled to the multi-sensor observation engine to normalize the plurality of disparate sensor readings.

11. The system of claim 8, further comprising a sensor data processing engine coupled to the spectrum correlation engine to transform the plurality of disparate sensor readings.

12. The system of claim 8, further comprising a sensor calibration module coupled to the multi-sensor observation engine to calibrate the plurality of disparate sensor readings.

13. The system of claim 8, further comprising a storage coupled to the validation engine to store the string of random integers.

14. The system of claim 8, wherein the device is a mobile phone.

15. A non-transitory computer readable medium comprising instructions, that when read by a processor, cause the processor to perform:
receiving a plurality of disparate sensor readings from a device;
determining a plurality of noise signals based on the plurality of disparate sensor readings;
correlating the plurality of noise signals;
generating a preliminary string of integers based on the correlated noise signals;
sampling the preliminary string of integers;
testing the sampled preliminary string of integers for randomness;
randomizing the tested preliminary string of integers, utilizing outputs from the device, if the tested preliminary string of integers are not random; and
validating a string of random integers based on the tested preliminary string of integers.

16. The non-transitory computer readable medium of claim 15, comprising instructions, that when read by the processor, cause the processor to perform determining a plurality of disparate sensors of the device.

17. The non-transitory computer readable medium of claim 15, comprising instructions, that when read by the processor, cause the processor to perform de-conflicting the plurality of disparate sensor readings.

18. The non-transitory computer readable medium of claim 15, comprising instructions, that when read by the processor, cause the processor to perform whitening the preliminary string of integers.

19. The non-transitory computer readable medium of claim 18, comprising instructions, that when read by the processor, cause the processor to perform retesting the whitened preliminary string of integers for randomness.

20. The non-transitory computer readable medium of claim 19, comprising instructions, that when read by the processor, cause the processor to perform whitening a portion of the tested preliminary string of integers that was found not random.
